(19) United States
(12) Patent Application Publication
(10) Pub. No.: US 2008/0290265 A1
(43) Pub. Date: Nov. 27, 2008

(54) SYSTEM AND METHOD OF CALIBRATING A MILLIMETER WAVE RADIOMETER USING AN OPTICAL CHOPPER

(76) Inventors: ROBERT PATRICK DALY, ORLANDO, FL (US); WILLEM H. REINPOLDT, III, WINDERMERE, FL (US); DENNIS LEE VANLANDUYT, PALM COAST, FL (US); SATISH KANTILAL PATEL, MOUNT DORA, FL (US); JASON REINHART, ORLANDO, FL (US)

Correspondence Address: McKinney Law, LLC, 390 N. Orange Avenue, Suite 2300, Orlando, FL, 32801, US

(21) Appl. No.: 12/124,204

(22) Filed: May 21, 2008

Related U.S. Application Data
(60) Provisional application No. 60/939,125, filed on May 21, 2007.

(51) Int. Cl. G01D 18/00

(52) U.S. Cl. 250/252.1

(57) ABSTRACT

A system of calibrating a millimeter wave radiometer using an optical chopper is disclosed. In a particular embodiment, the system includes a scanning mirror for reflecting millimeter wave energy from a scene and an optical chopper that is adapted to periodically interrupt the flow of the millimeter wave energy. The system further includes a synchronization processor for synchronizing oscillations of the scanning mirror with the movement of the optical chopper. In addition, a calibration processor calibrates the millimeter wave radiometer using a reference target of the optical chopper that has predetermined constant millimeter wave energy.

### I. CROSS REFERENCE TO RELATED APPLICATIONS

This application claims the benefit of U.S. Provisional Application No. 60/939,125 filed May 21, 2007. The disclosure of the provisional application is incorporated herein by reference.

### II. FIELD

The present invention relates in general to the field of millimeter wave radiometers, and in particular to a system and method of calibrating a millimeter wave radiometer using an optical chopper.

### III. DESCRIPTION OF RELATED ART

Scanning mirrors are often used in imaging systems for various applications such as a millimeter wave concealed object detection system. The millimeter wave imaging camera may employ an oscillating scanning mirror to project a representation of the 2-dimensional scene viewed by the camera onto a 1-dimensional radiometer (i.e., image sensor). The scanning mirror tilts back and forth to scan the imaging zone and redirect millimeter wave energy to a lens that focuses the millimeter wave energy to a radiometer.

As the scanning mirror reaches its scan limits, the scanning mirror must decelerate, stop, change direction and accelerate. This cycle is the inactive period of the scanning mirror, and unusable for imaging the scene viewed by the radiometer. Accordingly, a need exists in the art for a system and method to utilize the inactive period of the scanning mirror to synchronize the millimeter wave radiometer.

Another need exists in the art for a system and method of calibrating a millimeter wave radiometer that eliminates the need to periodically interrupt imaging the scene in the camera's field of view in order to reference the camera's imaging radiometer.

Another need exists in the art for a system and method of calibrating a millimeter wave radiometer that eliminates the need for a mechanical diverting mirror to divert the optics path for the radiometer referencing procedure.

Another need exists in the art for a system and method of calibrating a millimeter wave radiometer that improves the reliability and reduces the audible noise emissions of the imaging camera.

Another need exists in the art for a system and method of calibrating a millimeter wave radiometer that improves the performance and resolution of the imaging camera by providing the opportunity to reference the imaging radiometer at the start of each field and/or frame time.

Another need exists in the art for a system and method of calibrating a millimeter wave radiometer that reduces the cost and complexity of implementation versus mechanical servo solutions.

However, in view of the prior art at the time the present invention was made, it was not obvious to those of ordinary skill in the pertinent art how the identified needs could be fulfilled.

### IV. SUMMARY

In a particular embodiment, a system of calibrating a millimeter wave radiometer using an optical chopper is disclosed. The system includes a scanning mirror for reflecting millimeter wave energy from a scene and an optical chopper that is adapted to periodically interrupt the flow of the millimeter wave energy. The system further includes a synchronization processor for synchronizing oscillations of the scanning mirror with the movement of the optical chopper. In addition, a calibration processor calibrates the millimeter wave radiometer using a reference target of the optical chopper that has predetermined constant millimeter wave energy.

One particular advantage provided by embodiments of the system and method of calibrating a millimeter wave radiometer using an optical chopper is to briefly and periodically interrupt the optics path to synchronize with the oscillating scanning mirror or rotating polygonal mirror and thus exploit the mirror's inactive period for periodic referencing of the radiometer. In addition, multiple reference targets can be used on one or more reference targets, thus providing both “cold” and “hot” reference levels necessary for adjusting both the radiometer's offset and gain.

Another particular advantage provided by embodiments of the system and method of calibrating a millimeter wave radiometer using an optical chopper is the ability to use a Peltzer device to simultaneously provide a cold reference on one side and a hot reference on the other side of the reference target using the same device.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a flow diagram of a particular embodiment of a method of calibrating a millimeter wave radiometer using an optical chopper;

FIG. 1A is a block diagram of a particular embodiment of a system of calibrating a millimeter wave radiometer using an optical chopper;

FIG. 2 is a perspective view of a particular illustrative first embodiment of a system of calibrating a millimeter wave radiometer using an optical chopper;

FIG. 3 is a perspective view of a particular illustrative second embodiment of a system of calibrating a millimeter wave radiometer using an optical chopper;

FIG. 4 is a perspective view of a particular illustrative third embodiment of a system of calibrating a millimeter wave radiometer using an optical chopper;

FIG. 5 is a perspective view of a particular illustrative fourth embodiment of a system of calibrating a millimeter wave radiometer using an optical chopper;

FIG. 6 is a perspective view of a particular illustrative fifth embodiment of a system of calibrating a millimeter wave radiometer using an optical chopper;

FIG. 7 is a perspective view of a particular illustrative sixth embodiment of a system of calibrating a millimeter wave radiometer using an optical chopper;

FIG. 8 is a perspective view of a particular illustrative seventh embodiment of a system of calibrating a millimeter wave radiometer using an optical chopper; and

FIG. 9 is a partial elevational view of a particular illustrative eighth embodiment of a system of calibrating a millimeter wave radiometer using an optical chopper.

### VI. DETAILED DESCRIPTION

A system and method of calibrating a millimeter wave radiometer using a mechanical optical chopper is disclosed. The disclosed system provides a known reference level target to the millimeter wave radiometer on a high-frequency basis through the use of an optical chopper. This allows the millimeter wave radiometer to image the reference target on a per-frame or per-field basis for calibration. Accordingly, the present system and method could be used by the imaging community where the imaging sensor must be periodically referenced on a known reference target, as opposed to having the referencing/zeroing process performed electronically (as may be the case for CCD and CID based sensors).

The present system and method further provides for a means of synchronization of the optical chopper with the millimeter wave scanning mirror so that the reference target is injected into the optical path only during the inactive or otherwise predictable periods of the scanning mirror. In operation, the invention will cause the reference target, or a reflecting surface, to block the optical path synchronous to the scanning mirror's inactive period (where applicable). From the radiometer's perspective, this replaces the scene being viewed by the camera with a view of the reference target.

In a basic implementation the reference target would be constructed of, or covered with, a material or device that produces a known “reference” level to the radiometer. One implementation may use a millimeter absorbing foam covering. Another implementation may use a known temperature source. In a more advanced implementation, the reference target may produce one reference level on one side and another reference level on the opposite side. In another implementation, separate reference targets may be used to supply separate reference levels. In this fashion, coincident with the minimum sweep of the scan mirror a “low” reference level will be presented while coincident with the maximum sweep of the scan mirror a “high” reference level will be presented to the radiometer or vice versa.

The system is comprised of an electro-mechanical instrument and associated computer hardware and software. The computer hardware and software provide a means of controlling and synchronizing the instrument to the scanning mirror. Two possible implementations for providing the synchronization may include a phase locked loop (PLL) motor control circuit, or a computer controlled stepper motor with encoder feedback, or some other method.

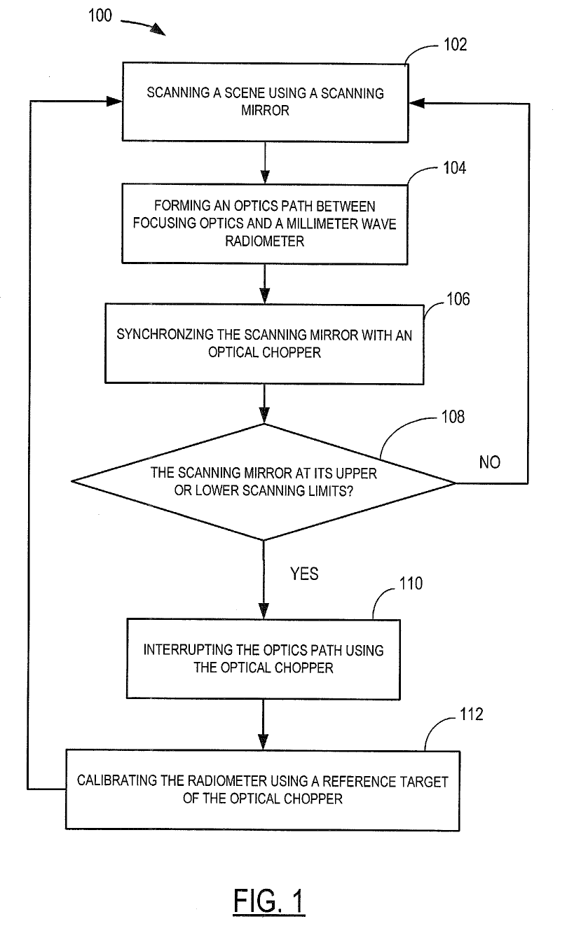

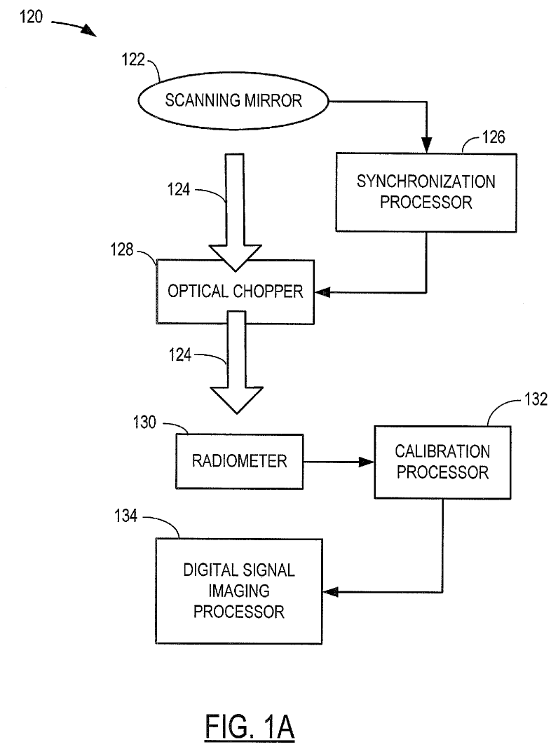

Referring to FIG. 1, a particular illustrative embodiment of a method of calibrating a millimeter wave radiometer using a mechanical optical chopper is disclosed and generally designated 100. Scanning a scene using a scanning mirror is initiated at 102. The mirror reflects millimeter wave energy from the scene to focusing optics thereby forming an optics path between the focusing optics and a millimeter wave radiometer at 104. The movement of the scanning mirror is synchronized with an optical chopper at 106. Next, whether the scanning mirror is an upper or lower scan limit is determined at 108. If the mirror is at a limit, then the optics path is interrupted using the optical chopper at 110. When the optics path is interrupted by the optical chopper, the radiometer detects a known reference level of millimeter wave energy associated with the optical chopper. Accordingly, the radiometer is calibrated using the reference level of the optical chopper at 112.

A block diagram of a particular embodiment of a system for calibrating a millimeter wave radiometer using a mechanical optical chopper is disclosed in FIG. 1A and generally designated 120. In a particular embodiment, the system 120 may be configured to perform the methods depicted in FIG. 1. The system 120 includes a scanning mirror 122 that reflects millimeter wave energy 124 through an optical chopper 128. A synchronization processor 126 synchronizes the oscillations of the scanning mirror with the movement of the optical chopper 128. The millimeter wave energy 124 from the scanning mirror 122 that is not interrupted or reflected by the optical chopper 128 is received by radiometer 130. A calibration processor 132 calibrates the radiometer using the known reference levels of the optical chopper that is received periodically by the radiometer 130. A digital signal imaging processor 134 processes the millimeter wave imagery 124 and is adaptable for combining video imagery and millimeter wave imagery 124 to generate composite images.

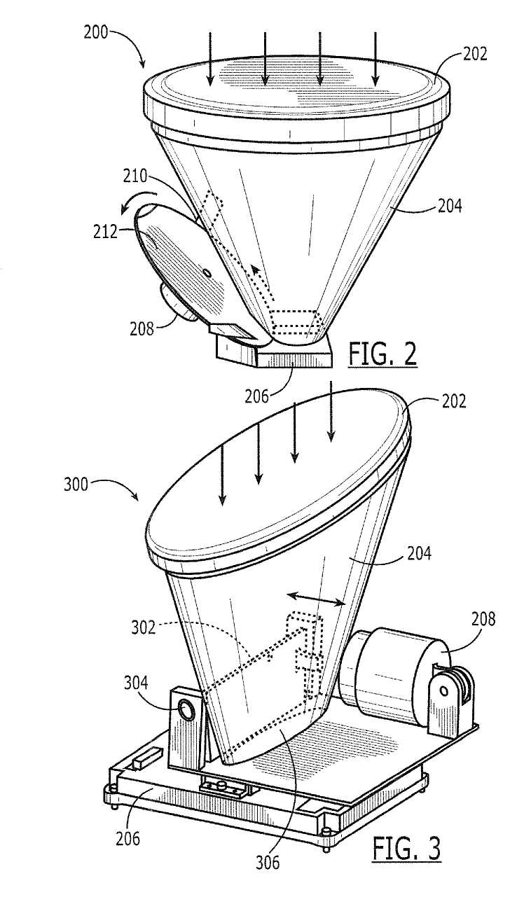

With reference to FIG. 2, a particular illustrative first embodiment of a system of calibrating a millimeter wave radiometer using an optical chopper is generally designated 200 and includes a circular disc 212 with one or more reference targets extending from radial spokes or extensions 210. In a particular embodiment, the system 200 may be configured to perform the methods and system depicted in FIGS. 1 and 1A. The reference targets would extend into and interrupt the optics path 204, preferably along the minimal dimension of the optics path and/or millimeter wave radiometer 206. The preferred location for the invention is between the radiometer 206 and the focusing optics 202. A computer controlled, phase-locked-loop controlled, or otherwise synchronized motor 208 causes the circular disc 212 to rotate synchronous to the scanning mirror. The radially extending reference target(s) 210 periodically interrupt the optics path 204. In another embodiment, the diameter of the circular disc 212 can approach zero so that the embodiment resembles one or more radial spokes extending from the axis of the shaft of the motor 208.

With reference to FIG. 3, a particular illustrative second embodiment of a system of calibrating a millimeter wave radiometer using an optical chopper is generally designated 300. In a particular embodiment, the system 300 may be configured to perform the methods and system depicted in FIGS. 1 and 1A and includes a motor 208, such as a computer controlled, phase-locked-loop controlled, or otherwise synchronized solenoid, cam or voice-coil or some other technique, which moves a supported pivoting member 302. The member 302 includes the reference target itself or a mirror for reflecting energy from the reference target to interrupt the optics path 204 and inject the reference target (or its reflection) into the field of view of the sensor 306 of the radiometer 206. The pivoting member 302 can be attached using a hinge, pivots or another technique, and can be attached from and supported by its top edge, bottom edge or side, or from any corner(s) to a base 304.

With reference to FIG. 4, a particular illustrative third embodiment of a system of calibrating a millimeter wave radiometer using an optical chopper is generally designated 400. In a particular embodiment, the system 400 may be configured to perform the methods and system depicted in FIGS. 1 and 1A and includes a cylinder 402 suspended in the optics path 204 of the millimeter radiometer 206. The axis of the cylinder 402 is perpendicular to the optics path 204. The cylinder 402 is computer controlled, phase-locked-loop controlled, or otherwise having a motor 208 that causes the cylinder 402 to rotate synchronous to the scanning mirror. The surface of the cylinder 402 is mostly open. One or more cylinder arms 406 connect the cylinder ends. One or more reference targets are imbedded into the cylinder arm(s) 406. In one embodiment, the reference target can be millimeter wave absorbing foam. In another embodiment, the reference target can be a constant temperature heat source. In yet another embodiment, the cylinder arm 406 may be an angled member of millimeter wave reflecting material (e.g., metal), which when directly over the radiometer 206 reflects a reference target into the sensor. While desirable for smoothness of operation and reliability, the axle on the most distant end of the cylinder 402 from the motor 208 is optional. The number of cylinder/reference arms 406 can be one or more. The reference target may be located on one or more of the cylinder arms 406 and positioned on the inside and/or outside of the arm 406.

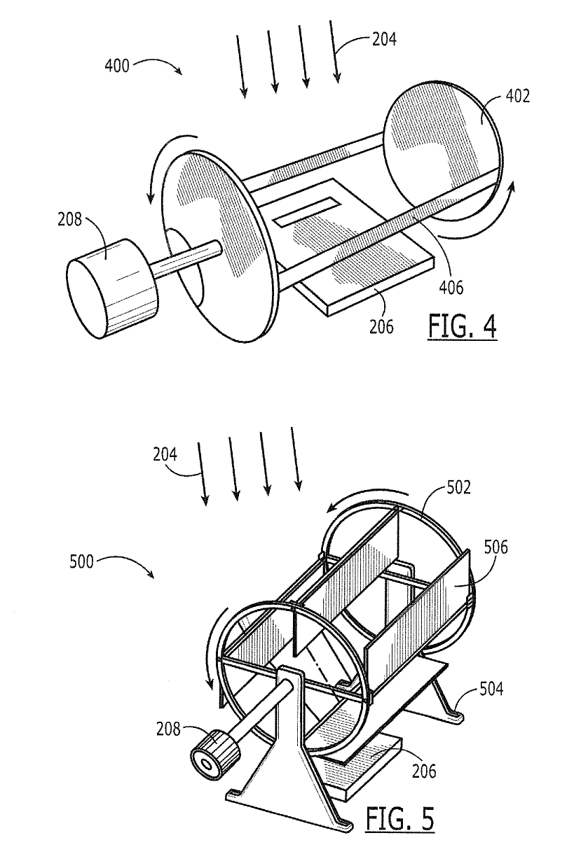

With reference to FIG. 5, a particular illustrative fourth embodiment of a system of calibrating a millimeter wave radiometer using an optical chopper is generally designated 500. In a particular embodiment, the system 500 may be configured to perform the methods and system depicted in FIGS. 1 and 1A and includes a rotating device having one or more support wheels 502 for suspending one or more reference targets 506 and periodically interrupting the optics path 204. The reference targets 506 can, in one implementation, be secured via a hinge or pivot so that a vertical orientation is obtained during motion about the path determined by wheel(s) 502 except at a designed position, such as immediately above radiometer 206, where the reference targets 506 will lay flat or in a better position to interrupt the optics path 204. This orientation change of reference targets 506 can be achieved by a touching architecture (not shown) which causes the reference targets 506 to pivot such as a rub strip or bar, or by track-work or guides that gently and gradually change the orientation of the reference targets 506. A computer controlled, phase-lock-loop controlled, or otherwise synchronized motor 208 causes the support wheels 502 to rotate synchronous to the scanning mirror.

For implementations where a straight-through optics path 204 is employed, the reference targets 506 will minimally interrupt the optics path 204 at the point of travel furthest away from the radiometer 206. The minimal interruption is due to the fact that the pivoting or hinged reference targets 506 are in their vertical orientation. This attribute can be masked by having a second reference target 506 diametrically opposite the first to purposely interrupt the optics path 204 concurrent with the return travel of the first reference target 506.

For implementations where an angled optics path is employed, a mirror or material reflective to millimeter wave energy (e.g., most metals) can be positioned inside of the optical chopper radius and direct the optics perpendicular to a single support wheeled implementation's plane of rotation.

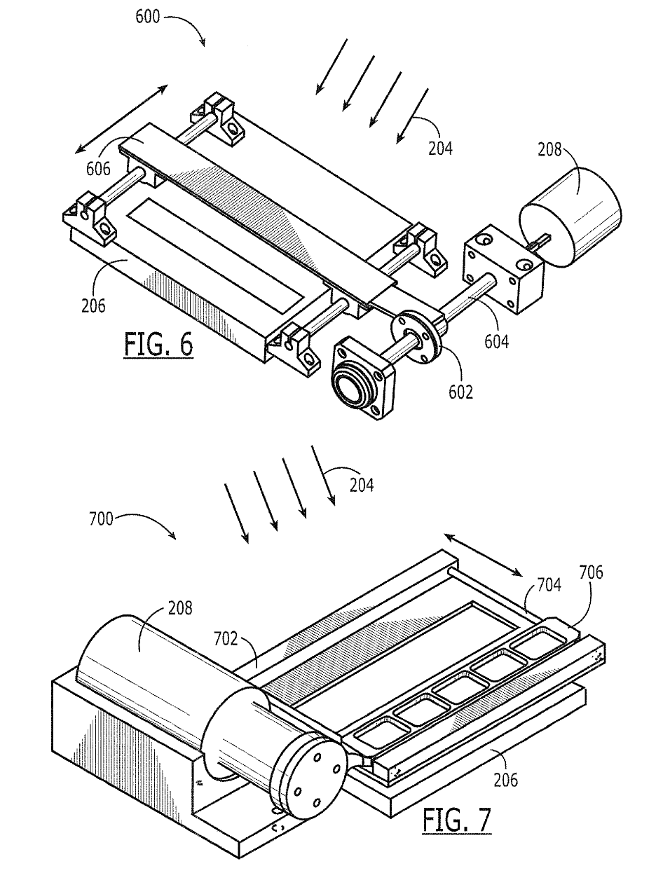

With reference to FIG. 6, a particular illustrative fifth embodiment of a system of calibrating a millimeter wave radiometer using an optical chopper is generally designated 600. In a particular embodiment, the system 600 may be configured to perform the methods and system depicted in FIGS. 1 and 1A and includes a motor 208 connected to a lead screw 604 which moves ball screw assembly 602 along the lead screw's 604 major axis, thus converting the rotational motion of the motor 208 into translational motion of the ball screw assembly 602 with or without the aid of gearing or transmission between motor 208 and lead screw 604. Ball screw assembly 602 connects to a sliding shutter device where a planar moving member 606 is supported on one or more hardened shafts. Planar member 606 can contain the reference target, contain a mirror or reflecting surface directing the optics path 204 from the radiometer 206 off the mirror onto the reference target, or the planar member 606 and the mirror/reflecting surface can be one and the same. The motor 208 is computer controlled, phase-locked-loop controlled, or otherwise synchronized with the scanning mirror so that the reference target is directed into the optics path 204 concurrent with the scanning mirror idle or turn-around time, or at a similarly convenient time.

With reference to FIG. 7, a particular illustrative sixth embodiment of a system of calibrating a millimeter wave radiometer using an optical chopper is generally designated 700. In a particular embodiment, the system 700 may be configured to perform the methods and system depicted in FIGS. 1 and 1A and includes a voice coil 208 which moves a sliding member 706 which travels on one or more support rails 704 secured to a base 702 to interrupt the optics path 204 and present the reference target or a reflecting surface into the field of view of the radiometer 206. The voice coil 208 is computer controlled, phase-locked-loop controlled, or otherwise synchronized with the scanning mirror so that the reference target is directed into the optics path 204 concurrent with the scanning mirror idle or turn-around time, or at a similarly convenient time. In this case, due to the limited mass-driving capacity of the voice coil 208, the sliding member 706 can be constructed of UHMW (Ultra-high Molecular Weight) Polyethylene or a similar material.

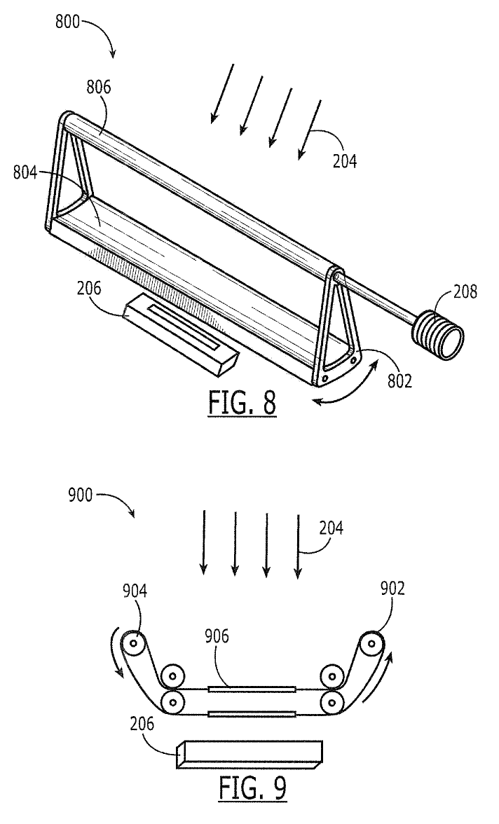

Referring now to FIG. 8, a particular illustrative seventh embodiment of a system of calibrating a millimeter wave radiometer using an optical chopper is generally designated 800. In a particular embodiment, the system 800 may be configured to perform the methods and system depicted in FIGS. 1 and 1A and includes a pendulum member 804. A motor 208, such as a computer controlled, phase-locked-loop controlled, or otherwise synchronized solenoid, cam or voice-coil or some other technique moves the pendulum member 804 containing the reference target itself or a mirror reflecting energy from the reference target to interrupt the optics path 204 and inject the reference target (or its reflection) into the field of view of the radiometer 206. The pendulum member 804 can be non-inverted, inverted, or horizontally mounted using a rotational axis 806 and frame member 802 that supports the pendulum member 804.

With reference to FIG. 9, a particular illustrative eighth embodiment of a system of calibrating a millimeter wave radiometer using an optical chopper is generally designated 900. In a particular embodiment, the system 900 may be configured to perform the methods and system depicted in FIGS. 1 and 1A and includes a single or multi-chain mechanism 902 having sprockets 904 that convey one or more reference targets 906 suspended within the optics path 204. The reference target 906 can be supported by and extending from a single chain 902, or supported by and bridging between multiple chains. In operation, a computer controlled, phased-locked-loop controlled, or otherwise synchronized motor drive would cause the chain(s) 902 to rotate in a unidirectional or bidirectional fashion so that the suspended reference target 906 periodically interrupts the optics path 204 at a known and advantageous time.

For unidirectional movement, the motion of the chain 902 can be continuous simplifying construction, increasing reliability and decreasing vibration and noise. Additionally, the length of the chain 902, position of the sprockets 904 and speed of the chain can be designed so that the reference target(s) 906 interrupt the optics path 204 at the desired time on both the “out bound” and “return bound” travel. The chain 902 can be implemented using metal or plastic chain link, metal or plastic banding, metal, plastic or rubber “timing” belts, or some other technique and/or material.

In another embodiment, a light weight reference target or mirror/reflecting surface is mounted directly onto a galvanometer, which is in turn controlled by a computer, phase-locked-loop, or otherwise to be synchronized with the scanning mirror.

In an alternative embodiment, the millimeter wave imaging camera may employ a rotating scanning polygon mirror to project a representation of the 2-dimensional scene viewed by the camera onto a 1-dimensional radiometer. The polygon mirror rotates its mirrored facets to project the image onto the radiometer. As each mirrored facet reaches its scan limits, the polygon mirror must then continue its rotation until the next mirrored facet is in position to start its scan process. This period is the inactive period of the polygon mirror's facets, and is unusable for imaging the scene viewed by the radiometer. Accordingly, a need in the art exists for a system and method to inject a reference into the optical path to reference the radiometer to a known level and perform a radiometric calibration during the inactive period.

The millimeter wave imaging system may directly image the 2-dimensional scene viewed by the camera onto a 2-dimensional radiometer through appropriate lensing and optics in another particular embodiment. In this case, the absence of a scanner eliminates idle time for the optics system and thus eliminates a convenient time to inject a reference into the optical path to reference the radiometer to a known level and perform a radiometric calibration. Here the process must be performed at a less convenient time.

In another particular embodiment, the scan angle of the oscillating scanning mirror is increased so that a reference target is projected onto the radiometer at the scanning mirror's extreme sweep angle(s). A facet angle can be added to the end(s) of the oscillating scanning mirror so that the scanning mirror is no longer flat or smoothly curved, but has a sharp reflecting angle at the end(s) of its sweep(s) to project a reference target onto the sensor. Alternatively, a facet angle is added to the end of a rotating polygonal scanning mirror so that the mirror facets are no longer flat or smoothly curved, but have a sharp reflecting angle at the ends of each facet to project a reference target onto the sensor.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system for calibrating a millimeter wave radiometer using an optical chopper, the system comprising:
a scanning mirror for reflecting millimeter wave energy from a scene;
an optical chopper wherein the optical chopper is adapted to periodically interrupt the flow of the millimeter wave energy;
a synchronization processor for synchronizing oscillations of the scanning mirror with movement of the optical chopper;
a millimeter wave radiometer for receiving the millimeter wave energy; and
a calibration processor for calibrating the radiometer.

2. The system of claim 1, further comprising focusing optics disposed between the scanning mirror and the optical chopper when using a substantially flat scanning mirror.

3. The system of claim 1, wherein the synchronization processor further comprising a phase locked loop motor control circuit.

4. The system of claim 1, further comprising a computer controlled stepper motor, voice coil or solenoid each with encoder feedback.

5. The system of claim 1, wherein the optical chopper further comprising a circular disc having at least one reference target extending outwardly from the circular disc and adapted to rotate synchronously with the scanning mirror.

6. The system of claim 1, wherein the optical chopper further comprising a planar reference target adapted to oscillate in front of the radiometer.

7. The system of claim 1, wherein the optical chopper further comprising:
an open cylinder adapted to synchronously rotate in front of the radiometer; and
at least one arm connecting a first end of the cylinder to a second end of the cylinder wherein the at least one arm having a reference target.

8. The system of claim 1, wherein the optical chopper further comprising at least one support wheel for suspending at least one planar reference target, wherein the at least one planar reference target adapted to pivot about an axis as the at least one support wheel is rotating.

9. The system of claim 1, wherein the optical chopper further comprising:
a lead screw for moving a ball screw assembly along an axis of the lead screw; and
a sliding shutter connected to the ball screw assembly, wherein the sliding shutter having a reference target and synchronized with the scanning mirror.

10. The system of claim 1, wherein the optical chopper further comprising:
a sliding planar reference target slidingly engaged between a pair of support rails; and
a voice coil for moving the planar reference target along the support rails synchronous with the scanning mirror.

11. The system of claim 1, wherein the optical chopper further comprising a planar reference target suspended from a rotational axis of a pendulum, wherein the pendulum swings synchronous with the scanning mirror.

12. The system of claim 1, wherein the optical chopper further comprising:
a plurality of sprockets for suspending at least one chain; and
the chain having at least one reference target, wherein the chain adapted to move the at least one reference target in front of a radiometer synchronous with the scanning mirror.

13. A method for calibrating a millimeter wave radiometer using an optical chopper, the method comprising:
scanning a scene using a scanning mirror to reflect millimeter wave energy to the millimeter wave radiometer;
forming an optics path between the scanning mirror and the millimeter wave radiometer;
synchronizing the scanning mirror with an optical chopper so that at least one reference target of the optical chopper is injected into the optical path during a predetermined time;
determining whether the scanning mirror is at a scanning limit;
interrupting the optics path using the optical chopper when the scanning mirror is at the scanning limit; and
calibrating the radiometer using the at least one reference target of the optical chopper.

14. The method of claim 13, further comprising providing a motor means for controlling and synchronizing the optical chopper.

15. The method of claim 14, wherein the motor means includes a phase locked loop motor control circuit.

16. The method of claim 14, wherein the motor means includes a computer controlled stepper motor, voice coil or solenoid each with encoder feedback.

17. The method of claim 13, further comprising referencing the radiometer at the start of each field or frame time.

18. The method of claim 13, wherein the scanning mirror is a rotating scanning polygon mirror that rotates mirrored facets to reflect millimeter wave energy to the radiometer.

19. The method of claim 13, wherein the at least one reference target further comprising a predetermined constant millimeter wave energy.

20. A system for calibrating a millimeter wave radiometer using an optical chopper, the system comprising:
at least one scanning mirror for reflecting millimeter wave energy from a scene;
a mechanical optical chopper wherein the optical chopper is adapted to periodically interrupt the flow of the millimeter wave energy using at least one reference target;
a millimeter wave radiometer for receiving the millimeter wave energy and adapted to calibrate when the at least one reference target is detected.
